(19) United States
(12) Patent Application Publication
(10) Pub. No.: US 2014/0235327 A1
(43) Pub. Date: Aug. 21, 2014

(54) GAMING MACHINE WITH ENHANCED PRIVACY FEATURES AND MECHANICS

(71) Applicant: WMS GAMING INC., Waukegan, IL (US)

(72) Inventors: Dion K. Aoki, Chicago, IL (US); Mary M. Burke, Somonauk, IL (US); Jacob C. Greenberg, Elgin, IL (US); Jordan M. Martone, Racine, WI (US)

(73) Assignee: WMS Gaming Inc., Waukegan, IL (US)

(21) Appl. No.: 13/770,680

(22) Filed: Feb. 19, 2013

(51) Int. Cl. G07F 17/32

(52) U.S. Cl. CPC G07F 17/323
USPC 463/25; 463/31

(57) ABSTRACT

A gaming system includes features to relay sensitive information to a player while keeping the sensitive information private from non-players. According to one aspect the gaming system comprises one or more input devices, one or more display devices for displaying a wagering game including sensitive and non-sensitive information, one or more processors, and one or more memory devices. The memory devices store instructions that cause the gaming system to display a plurality of images. The displayed images do not include the sensitive information. The instructions also cause the gaming system to provide an interactive feature configured to receive a predetermined user interaction via at least one of the one or more input devices. The instructions further cause the gaming system to display, in response to the predetermined user interaction with the interactive feature, a plurality of images, the displayed images including the sensitive information.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to a gaming machine with enhanced privacy features.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

### SUMMARY OF THE INVENTION

According to one aspect of the present invention, a gaming system comprises one or more input devices for receiving input from a user, one or more display devices for displaying a wagering game including sensitive and non-sensitive information, one or more processors, and one or more memory devices. The memory devices store instructions that, when executed by at least one of the one or more processors, cause the gaming system to display, via at least one of the one or more display devices, a plurality of images. The displayed images do not include the sensitive information. The instructions also cause the gaming system to provide an interactive feature configured to receive a predetermined user interaction via at least one of the one or more input devices. The instructions further cause the gaming system to display, in response to the predetermined user interaction with the interactive feature, a plurality of images, the displayed images including the sensitive information.

According to another aspect of the invention, a computer-implemented method in a gaming system comprises one or more input devices, one or more display devices, one or more processors, an optical filter, and one or more memory devices. The one or more input devices receive input from a user. The one or more display devices display a wagering game including sensitive and non-sensitive information. The optical filter is disposed on a portion of a surface of one of the one or more display devices. The optical filter is configured to relay an image from the one of the one or more display devices in a first direction away from the one of the one or more display devices. The optical filter is further configured to block the image from the one or more display devices in a second direction away from the one of the one or more display devices. The one or more memory devices store instructions that, when executed by at least one of the one or more processors, cause the gaming system to display, via the one of the one or more display devices, the sensitive information behind the optical filter such that the sensitive information is generally relayed in the first direction and such that the sensitive information is blocked in the second direction.

According to yet another aspect of the invention, a gaming system comprises one or more input devices, a gaming terminal, a barrier, and one or more memory devices. The one or more input devices receive input from a user. The gaming terminal includes one or more display devices. Each display device has a surface for displaying a wagering game including sensitive information and non-sensitive information. The barrier is disposed proximate to one of the one or more display devices and extends outwardly from the gaming terminal. The barrier is configured to not obstruct, in a first direction from a portion of the one of the one or more display devices, images displayed on the portion. The barrier is further configured to obstruct, in a second direction from the portion, the images displayed on the portion. The one or more memory devices store instructions that, when executed by at least one of the one or more processors, cause the gaming system to display, via the one of the one or more display devices, the sensitive information within the portion of the one of the one or more display devices.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming terminal according to an embodiment of the present invention.

FIG. 2 is a schematic view of a gaming system according to an embodiment of the present invention.

FIG. 3 is an image of an example basic-game screen of a wagering game displayed on a gaming terminal, according to an embodiment of the present invention.

FIG. 4A is an example basic-game screen of FIG. 3 with an interactive feature, according to an embodiment.

FIG. 4B is the example basic-game screen of FIG. 4A in response to user interaction, according to an embodiment.

FIG. 5A is an image of the example basic-game screen of FIG. 3 having optical filters as seen from a first direction, according to an embodiment.

FIG. 5B is the example basic-game screen of FIG. 5A from a second direction, according to an embodiment.

FIG. 6 is a perspective view of a gaming terminal having a barrier, according to an embodiment.

FIG. 7A is a perspective view of a gaming terminal having a barrier, according to an embodiment.

FIG. 7B is a side view of the gaming terminal of FIG. 7A.

FIG. 8 is a perspective view of a gaming terminal having barriers that are retractable, according to an embodiment.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

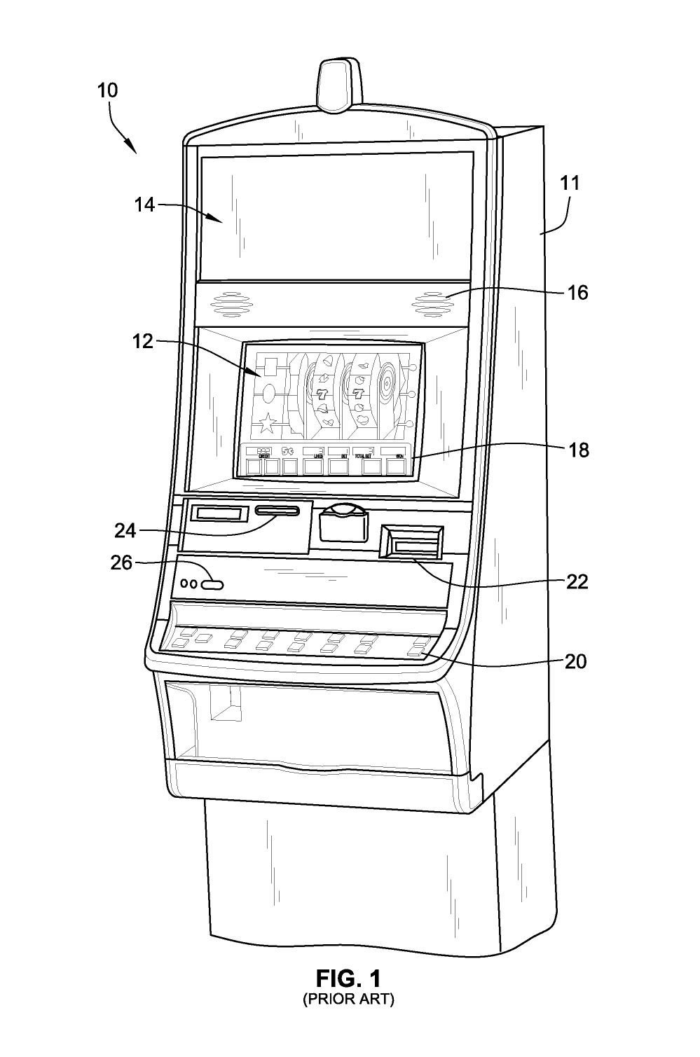

Referring to FIG. 1, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 and Patent Application Publication Nos. US2010/0069160 and US2010/0234099, which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

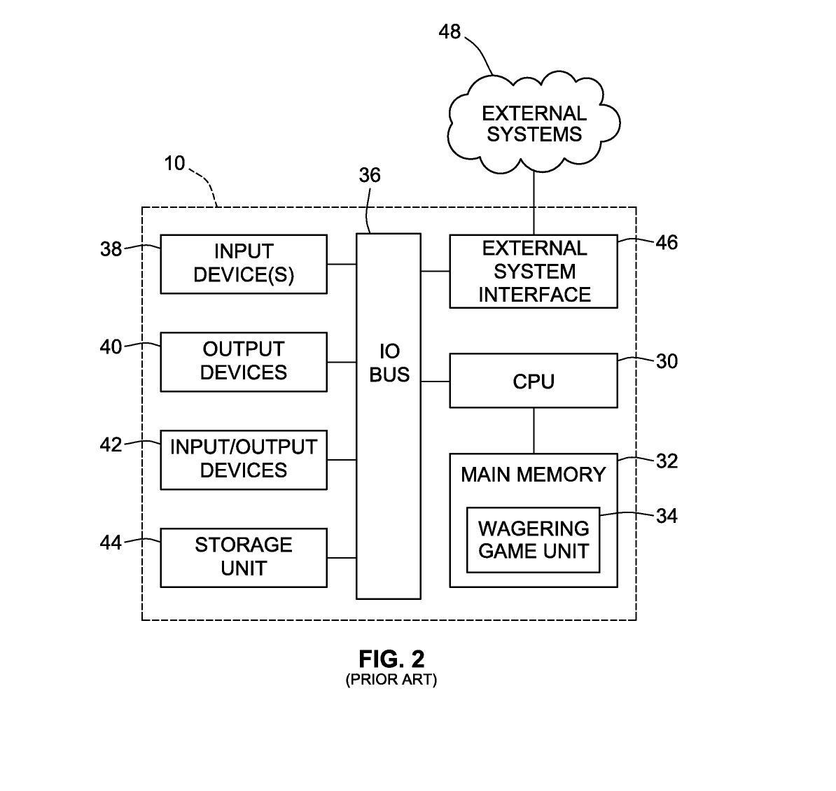

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

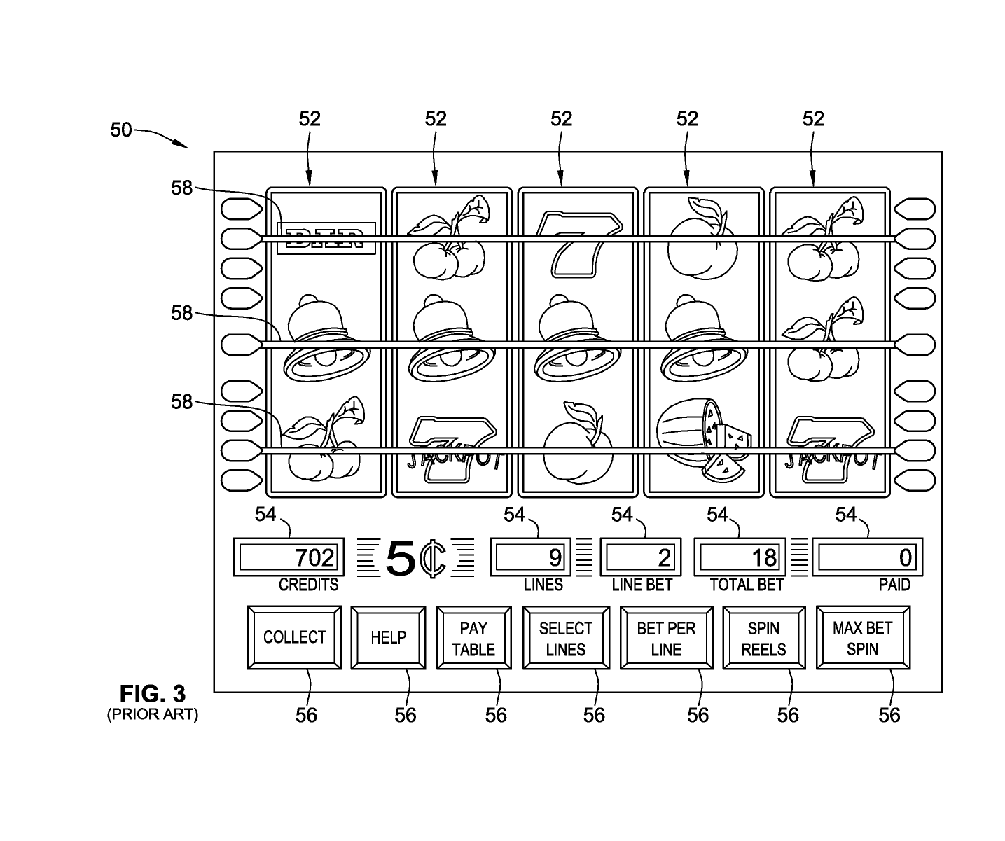

Referring now to FIG. 3, there is illustrated an image of a basic-game screen 50 adapted to be displayed on the primary display area 12, the secondary display area 14, a docked display area, or a device interfaced with the game terminal. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving an input indicative of a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

As described above, the game screen 50 displays one or more game-session credit meters 54. As shown in FIG. 3, the credit meters 54 indicate the number of total credits available for making wagers, the number of paylines selected for the current wager, the number of credits wagered for each selected payline in the current wager, the number of total credits currently wagered, and the number of credits awarded for the current wager. When the game screen 50 is shown on the primary display 12 or the secondary display 14, the credit meters 54 may be visible to anyone in the area around the gaming terminal 10. In other words, the information shown in the credit meters 54 can also be seen by people who are not playing the wagering game on the gaming terminal 10.

The number of total credits available for making wagers indicates how much the player has put into the gaming terminal 10 for wagers and/or how much the player has won or lost from playing the wagering game. If the number of total credits available is redeemable for money, the number of total credits indicates how much money the player currently possesses. In addition, the number credits currently wagered may indicate how much the player can afford to wager. In general, the credit meters 54 reveal some monetary or financial information about the player. Some players may want to keep their monetary or financial information private. Additionally, some players may not want to draw attention to the awards they receive for winning wagers. Accordingly, players may prefer to make the information provided by the credit meters at a gaming terminal less visible to others. To meet the preferences of these players, aspects of the present invention provide privacy features for displaying sensitive information on gaming terminals more discretely. In some aspects, the player is provided with an option to select the particular pieces or types of information that the player considers sensitive.

As also described above, the game screen 50 displays a plurality of simulated symbol-bearing reels 52 and—alternatively or additionally—a plurality of mechanical reels or other video or mechanical presentation consistent with the game format and theme. Further, entertaining animation associated with the game theme or advertising may be displayed on the game screen 50. Wagering game owners, such as casinos, and wagering game manufacturers benefit from this information being viewed by both the player and non-players. What is more, most players do not consider this information to be private and are not disturbed if others view the non-sensitive information. To meet the interests of these wagering game owners and/or manufacturers, this information can be generally described as non-sensitive information and can include information such as reels 52, touch-screen buttons 56, paylines 58, game outcomes, advertising, animations, sounds, bang-ups, etc. In some aspects, certain game outcomes, sounds, and/or animations are considered non-sensitive information (e.g., those associated with low-payout wins) while others are considered sensitive information (e.g., those associated with high-payout wins).

The interests of players, game owners, and/or game manufacturers can be balanced by displaying certain information only to a player while displaying other information to the player and also non-players. For example, displaying sensitive information only to the player while displaying non-sensitive information to the player and also non-players.

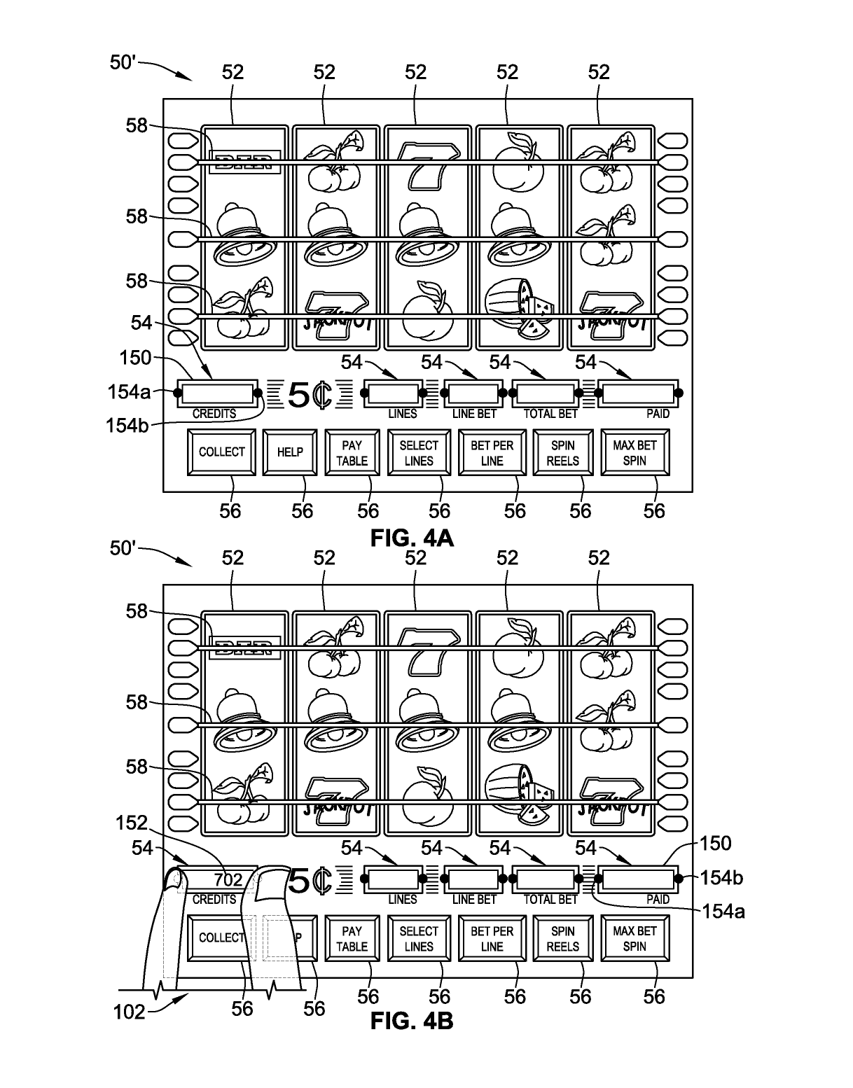

Referring now to FIGS. 4A and 4B, a basic-game screen 50′ adapted to display sensitive information only in response to a player input is shown according to an embodiment. FIG. 4A illustrates the basic-game screen 50′, including a plurality of images, before player interaction. FIG. 4B illustrates the basic-game screen 50′, including a plurality of images, in response to a player interaction.

The plurality of images of basic-game screen 50′ includes a plurality of symbol-bearing reels 52, game-session credit meters 54, and various touch screen buttons 56. As shown in FIG. 4A, before player interaction, each game-session credit meter 54 includes a field 150 and an interactive feature such as contact points 154a,b. As shown in FIG. 4B, each game-session credit meter 54, in response to player interaction, includes a field 150, a value 152 representing information associated with each credit meter 54 (e.g., monetary information), and contact points 154a,b. The value 152 can include numerical amounts, text strings, etc. The display of the value 152 associated with each game-session credit meter 54 transitions from a first state to the second state when a player 102 simultaneously contacts the first contact point 154a and the second contact point 154b associated with the game-session credit meter 54. In one aspect, the value 152 is displayed until the player 102 breaks the contact by removing a finger from the first contact point 154a and/or the second contact point 154b. In another aspect, the value 152 is displayed for predetermined period after the player 102 breaks contact with the first contact point 154a and/or the second contact point 154b. In yet another aspect, the value 152 is displayed for a predetermined duration after the player 102 initiates contact with the first and the second contact points 154a,b.

In some aspects, the fields are not displayed prior the player interaction. In response to the user interaction, the fields and associated values are displayed. This can be accomplished, for example, using an auto-hide feature. Without the player interaction, an image of the wagering game is displayed. In response to the player interaction, the sensitive information and associated fields are shown as overlying a portion of the image of the wagering game. Alternatively, the image of the wagering game may be resized to simultaneously display the full image of the wagering game and the fields with associated sensitive information. In yet another nonlimiting example, without the player interaction, the image of the wagering game is shown without the sensitive information. In response to the player interaction, the sensitive information is displayed without the image of the wagering game.

In some aspects, the value 152 of sensitive information is displayed both prior to the player interaction and after player interaction. Without the player interaction, the value 152 is displayed in a first font size that is small. In response to the player interaction, the sensitive information is displayed in a second font size that is larger than the first font size. In one nonlimiting example, the first size is not generally readable by non-players and the second size is easily readable by the player. Additionally or alternatively, the first size is barely readable by the player while the second size is easily readable by the player. For example, the first font size is between about 7 pixels high and about 16 pixels high while the second size is equal to or greater than about 26 pixels high. In some aspects, the second size is between about 40 pixels high and about 60 pixels high. In some aspects, the player may select the first size and/or the second size.

In some aspects, player interaction with the interactive feature includes, for example, a predetermined input via a button, joystick, touchscreen, or other input device. Input via the touchscreen may be sensed, for example, using a capacitive screen and/or a screen that detects applied pressure. Other input devices include devices that recognize movements and position of the player's body.

In one nonlimiting example, the player interaction includes the player 102 contacting an input device twice or more in rapid succession. In another nonlimiting example, the player interaction includes the player 102 contacting a predetermined area on the basic-game screen (e.g., a meter containing the desired information). In still yet another nonlimiting example, the player 102 contacts a combination of predetermined areas on the basic-game screen (e.g., two points on a meter containing the desired information). In a further nonlimiting example, the player interaction includes the player 102 tracing a predetermined pattern on the game screen (e.g., a circle around meter(s) containing the desired information). In a yet further nonlimiting example, combinations of player interaction are included in the wagering game such as the player contacting two points on a field or the player tapping the basic-game screen twice in rapid succession to display the associated value.

According to some aspects, a predetermined event is used instead of or in addition to the player interaction. The predetermined event can include, for example, a wagering game occurrence, user interaction with an interactive feature, etc. The wagering game occurrence can include, for example, a base-game outcome, bonus-game outcome, base-game feature, bonus-game feature, a change to a piece of sensitive information, a period of time elapsing, etc. In one nonlimiting example, a winning base-game outcome triggers display of sensitive information associated with the player's total credits for a predetermined time before the sensitive information is removed from the display. In another nonlimiting example, a withdrawal of credits from the player's online account triggers display of sensitive information associated with the player's remaining account credits. The sensitive information related to account credits is displayed until the user interacts with the gaming machine.

The response to the player interaction and/or predetermined event can be a specific response or a general response. A specific response occurs when the predetermined action causes the depiction of a particular piece of sensitive information to transition from the first state to the second state. For example, contacting a credit meter displays the sensitive information associated with that credit meter. A general response occurs when the predetermined event causes the depiction of a plurality of pieces of sensitive information to transition from the first state to the second state. For example, a player contacting the display twice, in rapid succession, displays the plurality of pieces of sensitive information until a predetermined occurrence happens such as a period of time elapsing or the player breaking contact with the display. The plurality of pieces of sensitive information can include, for example, all sensitive information, sensitive information of a specific type, sensitive information proximate to a particular area, a predetermined subset of all sensitive information, etc. One nonlimiting example of displaying sensitive information proximate to a particular area is to display all values within three inches of where the player contacts the touchscreen.

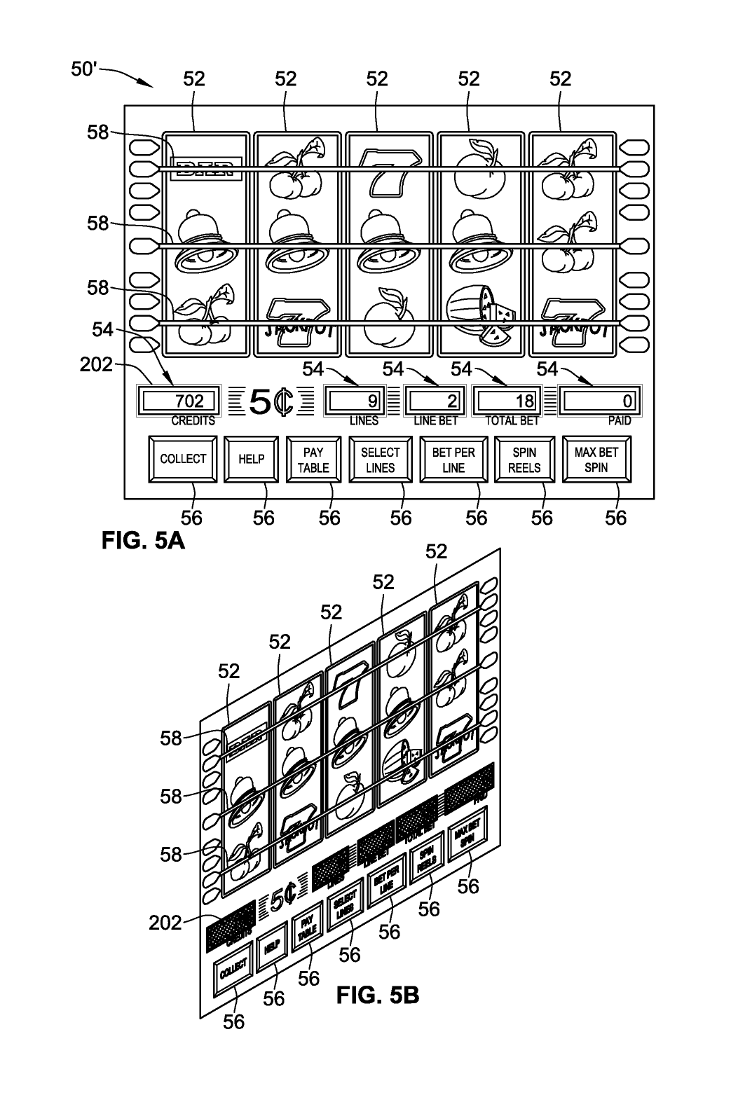

Referring now to FIGS. 5A and 5B, the example basic-game screen of FIG. 3 is shown having optical filters 202, according to one embodiment. In FIG. 5A, the example basic-game screen 50″ is illustrated as seen from a first direction. In FIG. 5B, the example basic-game screen 50″ is illustrated as seen from a second direction. The player views the basic-game screen 50″ from the first direction where any sensitive information behind the optical filters 202 is generally readable. Non-players view the basic-game screen 50″ from perspectives including the second direction where the sensitive information is generally not readable. The second direction can include, for example, lines-of-sight of persons at adjacent machines and/or persons walking past the player's machine.

A variety of optical filters can be used to create readable sensitive information from the first direction but not the second direction. These optical filters can include a multi-level substrate, lenses, magnification arrays, parallax barriers, etc. One nonlimiting example of a multi-level substrate includes a substrate having a microlouver pattern thereon. An optical filter using a multi-level substrate is generally transparent or generally translucent when viewed from certain angles, but is substantially opaque when viewed from other angles. In some aspects, the first direction is generally perpendicular to the optical filter and the second direction is at an angle such as 0°, 30°, 45°, 60° or 80° from the screen. Alternatively, the second direction can be a range of angles including a range such as from 0° to 30°, 45°, 60° or 80°. In some aspects, the sensitive information is readable from a first plurality of ranges and not readable from a second plurality of ranges. By way of nonlimiting examples, the first plurality of ranges can include 0° to 30° and 80° to 100° and the second plurality of ranges can include 30° to 80° and 100° to 150°. Thus, persons at adjacent machines and persons passing by the player's gaming terminal cannot discern the sensitive information despite the sensitive information being constantly displayed to the player.

Lenses or magnification arrays can be used to relay an image from the screen when viewed at a first point but distort the image when viewed at a second point. In some aspects, the first point and the second point are different positions in a first direction away from the screen. Also, in some aspects, the first point and the second point are equidistant from the screen. For example, a micro-lens array can be used to relay an image from the screen to a plurality of points along a line while distorting the image or relaying a different image to points not along the line. Thus, persons at adjacent machines and persons passing by the player's gaming terminal can see light from the images disposed behind the optical filter, but cannot discern the sensitive information despite the sensitive information being constantly displayed to the player.

Parallax barriers can be used to relay a first image and a second image from the screen. The first image and the second image occupy the same area on the screen. The parallax barrier relays the first image in a first direction but not in a second direction. The parallax barrier simultaneously relays the second image in the second direction but not in the first direction. In one nonlimiting example, the first image is a credit meter and the first direction is generally toward a player while the second image is a part of the thematic indicia and the second direction is generally toward persons at adjacent machines. Thus, the sensitive information is kept private to the player and the game maintains aesthetically appeal because the parallax barrier does not cause a void in the theme that attracts the eyes of non-players.

Beneficially, optical filters can be applied only to certain portions of the display. This allows non-players to view non-sensitive information such as the reels and animations. Further, application to only portions of the display is beneficial to the player because an optical filter on the entire display would affect the player's view of the game screen. For example, images near the periphery of the display would be obstructed because a player's view angle becomes shallower, leading to player dissatisfaction.

A further benefit of applying optical filters only to sensitive information is the ability to provide the player with privacy and/or security while complying with gaming regulations. Certain regulations require specific information to be displayed to the player at all times. Optical filters placed over this information would comply with these regulations because the sensitive information would always be readable to the player, but the sensitive information would be private because only the player can see it.

Advantageously, the optical filters can include elements of the game theme so that they do not detract from the gaming terminal's appearance. In one aspect, this is done by selecting an optical filter having a color when viewed from non-player perspectives. For example, an optical filter having a gold color when viewed from non-player perspectives could be incorporated into an image of a coin or a pot of gold. In another aspect, the optical filter can incorporate an image that is visible when viewed from non-player perspectives. For example, an optical filter could appear as stacks of money, currency symbols, or even a character of the game theme when viewed from non-player perspectives.

The optical filters 202 can be made of a variety of materials including transparent, translucent, and/or opaque materials. These materials may additionally transfer user contact with the portion of the optical filter 202 to a portion of the screen using, for example, electrical conductivity. Additionally, the optical filters 202 may be permanently, semi-permanently, or temporarily attached to the screen. One nonlimiting example of permanent attachment uses non-removable adhesives such as cyanoacrylate. One nonlimiting example of semi-permanent attachment uses materials that lose their adhesive properties when contacted with light, heat, and/or chemicals. One nonlimiting example of temporary attachment may be accomplished using static cling materials.

In addition to or alternatively to optical filters, other forms of optical manipulation can be used. In one aspect, lenses are used that have a focal point at the player position, but not non-player positions. In another aspect, the sensitive information is obscured by patterns and/or colors and the player is provided with a moveable filter. The patterns and/or colors make it difficult for a person to see the sensitive information without the moveable filter. However, when the player places the moveable filter between the player's eye and the sensitive information, the sensitive information becomes readable to the player. For example, sensitive information that is displayed as blue text with a red and white obscuring pattern becomes readable when a red-colored filter is placed between the player's eye and the sensitive information.

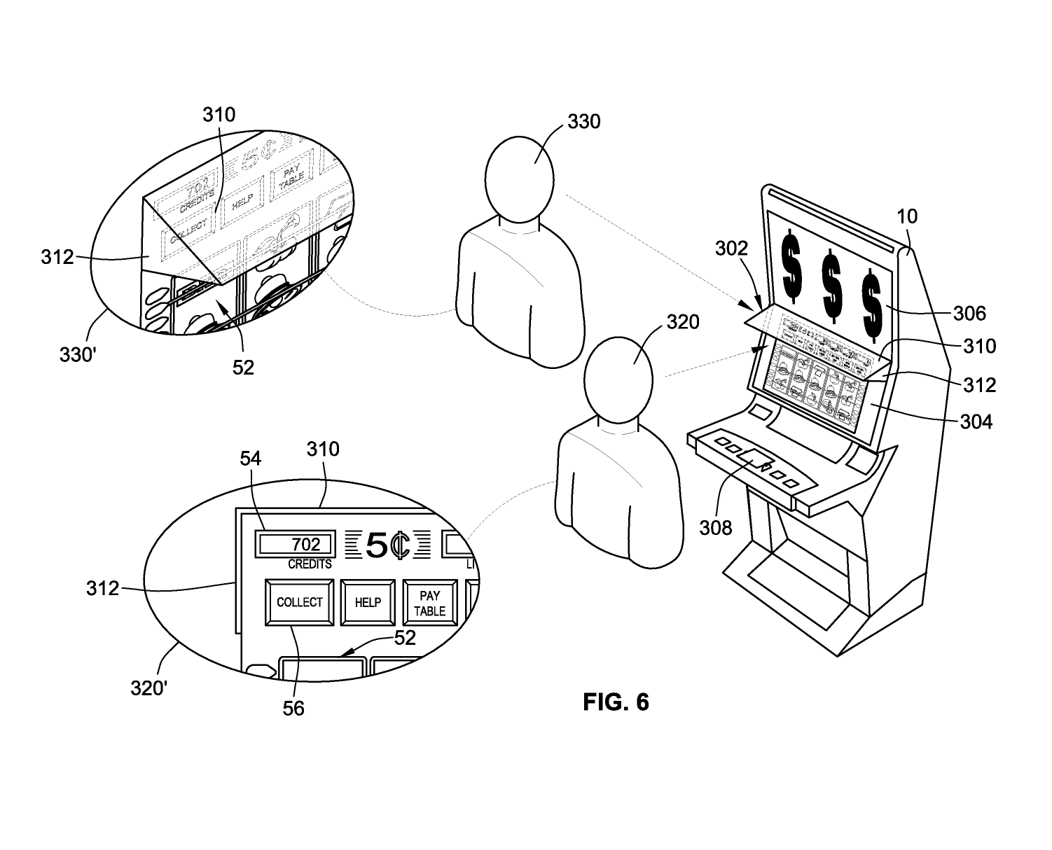

FIG. 6 is a perspective view of a gaming terminal 10 having a barrier 302, according to an embodiment. The gaming terminal 10 includes a primary display 304 with the barrier 302 disposed near the top thereof, a secondary display 306, and a tertiary display 308. In some aspects, the barrier 302 is disposed proximate to the secondary display 306 and/or the tertiary display 308. The barrier 302 includes a generally flat top surface 310 and generally flat side surfaces 312. The barrier 302 is configured to obstruct the view of images in a first direction from the primary display 304, but not obstruct view of images in a second direction from primary display device 304. Further, the barrier 302 only obstructs a portion of the primary display device 304. In one aspect, the primary display 304 includes both sensitive information and non-sensitive information. The sensitive information is disposed on the portion of the primary display that is obstructed in the second direction.

A player 320 and a non-player 330 are shown viewing the gaming terminal 10. Player view 320′ illustrates a portion of the gaming terminal 10 from the player's 320 perspective including the top surface 310 and side surface 312 of the barrier 302. Non-player view 330′ illustrates a portion of the gaming terminal 10 from the non-player's 330 perspective including the top surface 310 and side surface 312 of the barrier 302.

The player view 320′ includes both sensitive and non-sensitive information. In one aspect, the sensitive information is located above the reels 52 rather than the typical placement below the reels 52. The placement of the sensitive information can be predetermined by, for example, the game manufacturer or the player may be allowed to move the sensitive information to a desired position on any of the displays. As shown, the barrier 302 obscures little to none of player view 320′ of the primary display 304, secondary display 306, or tertiary display 308.

The non-player view 330′ includes non-sensitive information and the barrier 302. The barrier 302 obscures substantially all of the player's 320 sensitive information, but allows the non-player to see non-sensitive information such as the reels 52, advertisements, game animations, etc.

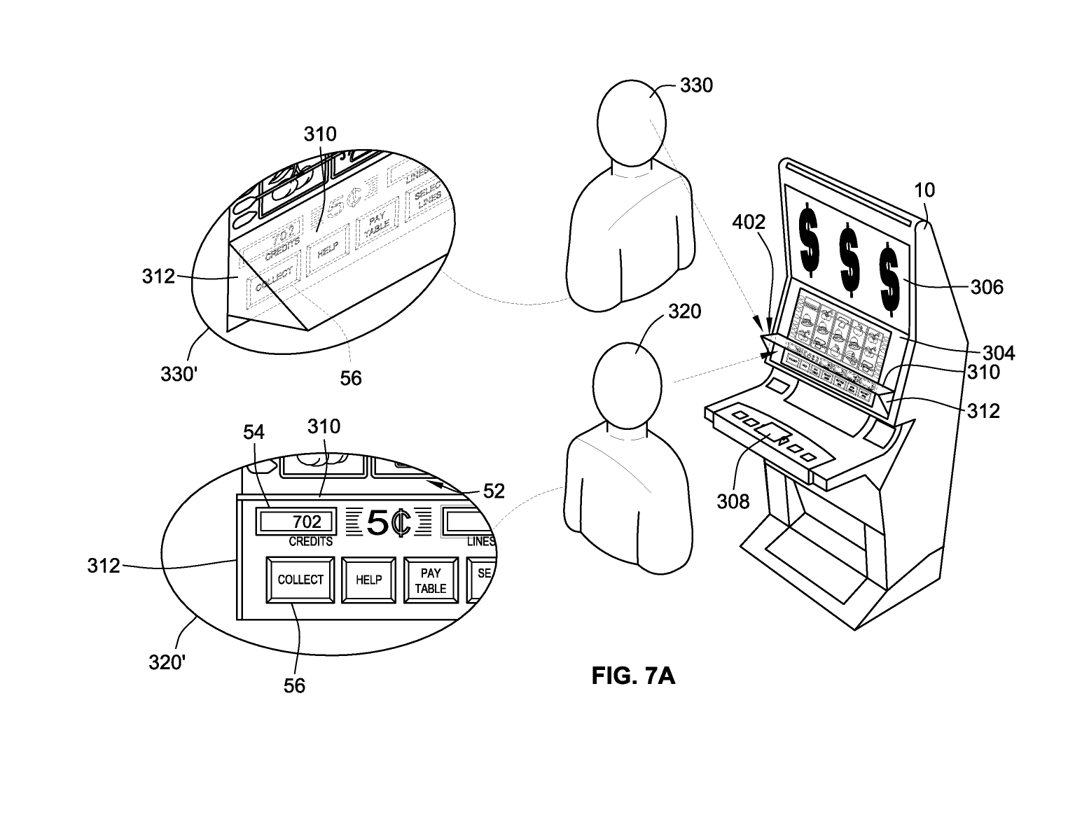

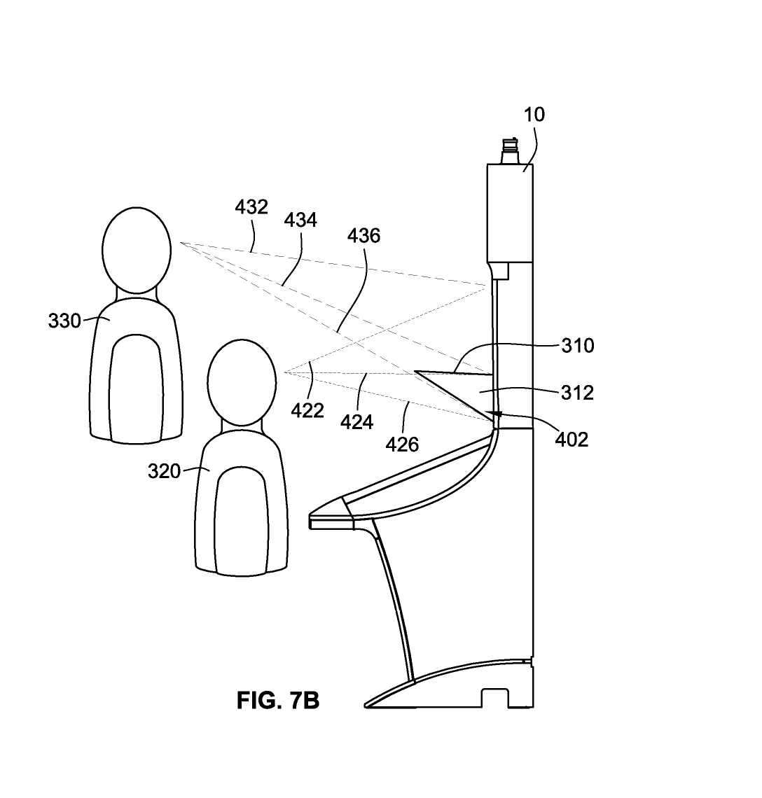

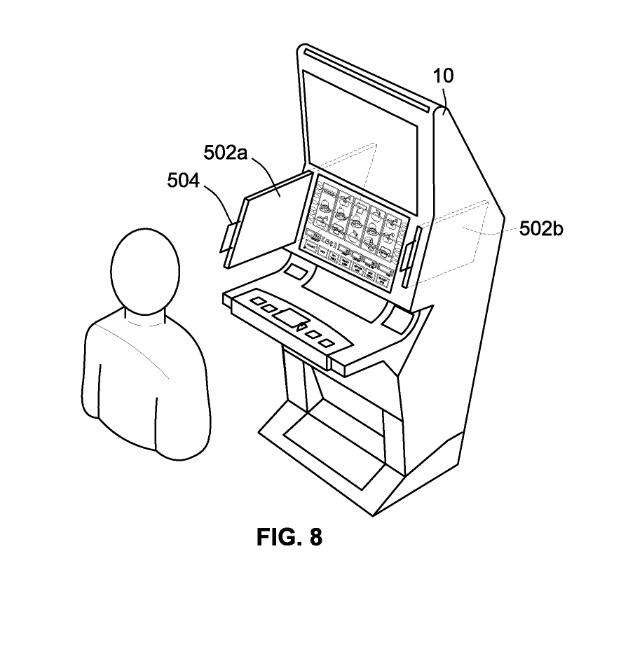

FIG. 7A is a perspective view of a gaming terminal 10 having a barrier 402, according to an embodiment. The gaming terminal 10 includes a primary display 304, a secondary display 306, and a tertiary display 308. The barrier 402 extends across the surface of the primary display device 304. Additionally or alternatively, the barrier may be included on the secondary and or the tertiary display 306, 308. The barrier 402 includes a generally flat top surface 310 and generally flat side surfaces 312. The barrier 402 is configured to obstruct the view of images in a first direction from the primary display 304, but not obstruct the view of images in a second direction from primary display device 304. Further, the barrier 402 only obstructs a portion of the primary display device 304. In one aspect, the primary display 304 includes both sensitive information and non-sensitive information. The sensitive information is disposed on the portion of the primary display that is obstructed in the second direction.

In the illustrated aspect, the sensitive information is displayed below the reels 52. The barrier 402 is disposed between the reels 52 and the area containing sensitive information. In one aspect, the reels 52 and the area containing sensitive information are contained on separate displays.

A player 320 and a non-player 330 are shown viewing the gaming terminal 10. Player view 420′ illustrates a portion of the gaming terminal 10 from the player's 320 perspective including the top surface 310 and side surface 312 of the barrier 402. Non-player view 430′ illustrates a portion of the gaming terminal 10 from the non-player's 330 perspective including the top surface 310 and side surface 312 of the barrier 402.

The player view 420′ includes both sensitive and non-sensitive information. The top side 310 of the barrier 402 is disposed between the reels 52 and the area containing sensitive information. As will be discussed in further detail with reference to FIG. 7B, the barrier 402 is configured to obscure little of the player view 420′.

The non-player view 430′ includes the top surface 310 and side surface 312 of the barrier 402 and the non-sensitive information. The barrier obscures substantially all of the player's 320 sensitive information, but allows the non-player 330 to see non-sensitive information such as the reels 52, advertisements, game animations, etc.

FIG. 7B is a side view of the gaming terminal 10 of FIG. 7A. A plurality of player sightlines 422, 424, 426 and non-player sightlines 432, 434, 436. The first player-sightline 422 and the first non-player-sightline 432 travel to the top of the primary display. The second player-sightline 424 and second non-player-sightline 434 travel to point of contact between the top surface 310 of the barrier 402 and the display. The third player-sightline 426 and the third non-player-sightline 436 travel to the point of contact between the bottom of the side surface 312 and the gaming terminal 10.

The player 320 can view the display generally between the first and the third player-sightlines 422, 426. The top surface 310 of the barrier 402 is generally parallel to the second player-sightline 424 so that the display is generally not obscured and the player 320 may easily see both the sensitive and non-sensitive information. The non-player 330 can view the display generally between the first and the second non-player-sightline 432, 434. However, the top surface 310 is of sufficient length to obscure at least a portion of the sensitive information disposed below the barrier 402.

FIG. 8 is a perspective view of a gaming terminal having barriers 502a,b that are retractable, according to an embodiment. In an aspect, the retractable barriers 502a,b include a handle 504 that a player may grasp to extend and/or retract the retractable barriers 502a,b. In another aspect, the retractable barriers 502a,b are mechanically extendable and/or retractable in response to player input and/or a predetermined event. The predetermined event can include the player initiating play, a period of time with zero credits in the gaming terminal 10, the player cashing out of the gaming terminal 10, a period of time without player input, a period of time between subsequent spins, etc.

Beneficially, retractable barriers 502a,b can be used to display advertising information for a casino or a gaming machine manufacturer while the retractable barriers 502a,b are extended. In addition, the retractable barriers 502a,b allow animations and other attract sequences to be viewed by non-players while the gaming terminal 10 is not occupied by a player 10, thus attracting non-players to initiate a wagering game.

In some aspects a gaming system includes one or more input devices for receiving input from a user, one or more display devices for displaying a wagering game including sensitive and non-sensitive information, one or more processors, and one or more memory devices storing instructions. The instructions, when executed by at least one of the one or more processors, cause the gaming system to display, via at least one of the one or more display devices, a plurality of images including the non-sensitive information in a first font size and the sensitive information in a second font size, the second font size being smaller than the first font size. The instructions also cause the gaming system to provide an interactive feature configured to receive a predetermined user interaction via at least one of the one or more input devices. The instructions further cause the gaming system to display, in response to the predetermined user interaction with the interactive feature, the plurality of images including the sensitive information in a third font size, the third font size being larger than the second font size. In some aspects, the third font size is equal to the first font size. In some aspects, the non-sensitive information includes at least one of a plurality of symbols, advertisements, or animations.

In some aspects, the sensitive information includes a value stored on at least one of the one or more memory devices, the value not being altered by the predetermined user interaction. In some further aspects, the value is an amount of credits.

In some aspects, a gaming system comprises one or more input devices for receiving input from a user, one or more processors, one or more display devices for displaying a wagering game including sensitive and non-sensitive information, an optical filter, and one or more memory devices storing instructions. The optical filter is disposed on a portion of a surface of one of the one or more display devices. The optical filter is configured to relay an image from the one of the one or more display devices to a first point in a first direction away from the one of the one or more display devices. The optical filter is further configured to distort the image from the one or more display devices to a second point in a second direction away from the one of the one or more display devices. The instructions, when executed by at least one of the one or more processors, cause the gaming system to display via the one of the one or more display devices, the sensitive information behind the optical filter such that the sensitive information is generally relayed at the first point and such that the sensitive information is distorted at the second point.

In some aspects, the first point and the second point are equidistant from the optical filter. In some aspects, the first direction and the second direction are the same. In some aspects, the one or more optical filters are temporarily attached to at least one of the one or more displays.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

1. A gaming system comprising:
one or more input devices for receiving input from a user;
one or more display devices for displaying a wagering game including sensitive and non-sensitive information;
one or more processors; and
one or more memory devices storing instructions that, when executed by at least one of the one or more processors, cause the gaming system to:
display, via at least one of the one or more display devices, a plurality of images, the displayed images not including the sensitive information;
provide an interactive feature configured to receive a predetermined user interaction via at least one of the one or more input devices;
display, in response to the predetermined user interaction with the interactive feature, a plurality of images, the displayed images including the sensitive information.

2. The gaming system of claim 1, wherein the predetermined user interaction includes contacting at least one of the one or more input devices at least twice in rapid succession.

3. The gaming system of claim 1, wherein the predetermined user interaction contacting at least one of the one or more display devices in one or more predetermined areas.

4. The gaming system of claim 1, wherein the predetermined user interaction includes tracing a predetermined pattern on at least one of the one or more display devices.

5. The gaming system of claim 1, wherein the plurality of images, prior to receiving the predetermined user interaction, includes a plurality of fields and the plurality of images, after receiving the predetermined user interaction, includes at least one piece of sensitive information displayed within at least one of the fields.

6. The gaming system of claim 5, wherein each field includes two points disposed thereon and the predetermined user interaction includes the player contacting the two points on one of the plurality of fields, the at least one piece of sensitive information displayed being the sensitive information associated with the one of the plurality of fields.

7. The gaming system of claim 1, wherein the non-sensitive information includes at least one of a plurality of symbols, advertisements, or animations.

8. The gaming system of claim 1, wherein the sensitive information includes a value stored on at least one of the one or more memory devices, the value not being altered by the predetermined user interaction.

9. The gaming system of claim 8, wherein the value is an amount of credits.

10. The gaming system of claim 1, wherein the sensitive information includes at least one of account credits, game-session credits, win meters, wagers, and player identification.

11. The gaming system of claim 1, wherein the plurality of pieces of information are moveable by a user and wherein the user may move the information to a desired location on at least one of the one or more displays.

12. A gaming system comprising:
one or more input devices for receiving input from a user;
one or more processors;
one or more display devices for displaying a wagering game including sensitive and non-sensitive information;
an optical filter disposed on a portion of a surface of one of the one or more display devices, the optical filter being configured to relay an image from the one of the one or more display devices in a first direction away from the one of the one or more display devices, the optical filter being further configured to block the image from the one or more display devices in a second direction away from the one of the one or more display devices; and
one or more memory devices storing instructions that, when executed by at least one of the one or more processors, cause the gaming system to display, via the one of the one or more display devices, the sensitive information behind the optical filter such that the sensitive information is generally relayed in the first direction and such that the sensitive information is blocked in the second direction.

13. The gaming system of claim 12, wherein the one or more optical filters includes an optical filter having a multi-level substrate.

14. The gaming system of claim 12, wherein the one or more optical filters are temporarily attached to at least one of the one or more displays.

15. The gaming system of claim 12, wherein the sensitive information is moveable by a user to a desired location on at least one of the one or more displays.

16. The gaming system of claim 12, wherein the first direction is generally perpendicular to the surface of the one of the one or more display devices.

17. The gaming system of claim 12, wherein the optical filter is configured to block a range of directions including the second direction.

18. The gaming system of claim 17, wherein the range of directions includes from about 30° to at least about 60° relative to the first direction.

19. The gaming system of claim 17, wherein the range of directions includes from 0° to at least about 30° relative to the surface.

20. A gaming system comprising:
one or more input devices for receiving input from a user;
a gaming terminal including one or more display devices, each display device having a surface for displaying a wagering game including sensitive information and non-sensitive information;
a barrier disposed proximate to one of the one or more display devices and extending outwardly from the gaming terminal, the barrier configured to not obstruct, in a first direction from a portion of the one of the one or more display devices, images displayed on the portion, the barrier further configured to obstruct, in a second direction from the portion, the images displayed on the portion; and
one or more memory devices storing instructions that, when executed by at least one of the one or more processors, cause the gaming system to display, via the one of the one or more display devices, the sensitive information within the portion of the one of the one or more display devices.

21. The gaming system of claim 20, wherein the barrier includes a generally flat top surface disposed between a top and a bottom of the one of the one or more display devices.

22. The gaming system of claim 20, wherein the barrier is opaque.

23. The gaming system of claim 20, wherein the barrier is translucent.

24. The gaming system of claim 20, wherein the sensitive information is moveable by a user and wherein the user may move the sensitive information to a desired location on at least one of the one or more displays.
